(19) United States
(12) Patent Application Publication
(10) Pub. No.: US 2024/0278335 A1
(43) Pub. Date: Aug. 22, 2024

(54) FINISHING BORING MACHINE FOR HIGH-PRECISION WHEEL HUB HOLE

(71) Applicant: NSH-CTI Machine Tool (Jiangxi) Co., Ltd., Nanchang (CN)

(72) Inventors: Haiquan ZHOU, Nanchang (CN); Xi JIANG, Nanchang (CN); Desheng ZHU, Nanchang (CN); Jianfeng YANG, Nanchang (CN); Wei WANG, Nanchang (CN); Jibo DENG, Nanchang (CN); Jincheng ZHOU, Nanchang (CN); Yulin HONG, Nanchang (CN); Xiaolong ZHANG, Nanchang (CN)

(73) Assignee: NSH-CTI Machine Tool (Jiangxi) Co., Ltd., Nanchang (CN)

(21) Appl. No.: 18/192,622

(22) Filed: Mar. 29, 2023

(30) Foreign Application Priority Data
Feb. 21, 2023 (CN) 202310145373.7

(51) Int. Cl. B23B 41/16; B23B 47/34

(52) U.S. Cl. CPC B23B 41/16; B23B 47/34; B23B 2215/08

(57) ABSTRACT

A finishing boring machine for a high-precision wheel hub hole, includes: a boring machine body, a hydraulic automatic centering fixture, a computer numerical control (CNC) vertical sliding table, a spindle box, a CNC facing head, a cutter assembly, and a hydraulic system. The boring machine body is a main structure of the finishing boring machine for the wheel hub hole. The hydraulic automatic centering fixture is configured to place a to-be-processed workpiece, and is arranged on the boring machine body. The CNC vertical sliding table is configured to control operation of the CNC facing head, and is arranged on the boring machine body. The spindle box is configured to control an operation speed of the CNC facing head, and is arranged on the CNC vertical sliding table. The CNC facing head is configured to control the cutter assembly to process the to-be-processed workpiece, and is arranged on the spindle box.

### CROSS-REFERENCE TO RELATED APPLICATIONS

This application claims priority to Chinese Patent Application No. 202310145373.7 with a filing date of Feb. 21, 2023. The content of the aforementioned applications, including any intervening amendments thereto, is incorporated herein by reference.

### TECHNICAL FIELD

The present disclosure relates to railway vehicle equipment machinery, and in particular, to a finishing boring machine for a high-precision wheel hub hole.

### BACKGROUND

At present, the high-speed railway technology is continuously changing, and the train runs increasingly fast, which constantly updates the design requirements of wheels and has higher requirements for processing of wheel hub holes. Further, the corresponding equipment machinery needs to be updated in time to adapt to the progress of technology. The wheel hub holes require high precision, and are mainly processed by the vertical lathe traditionally, which has low production efficiency and difficult quality control, and cannot meet the current technical development requirements.

### SUMMARY OF PRESENT INVENTION

A technical problem to be solved by the present disclosure is to provide a finishing boring machine for a high-precision wheel hub hole, aiming at low production efficiency and difficult quality control of an existing wheel hub hole machining boring machine.

To solve the above technical problem, embodiments of the present disclosure provide a finishing boring machine for a high-precision wheel hub hole, including: a boring machine body, a hydraulic automatic centering fixture, a computer numerical control (CNC) vertical sliding table, a spindle box, a CNC facing head, and a cutter assembly.

The boring machine body is a main structure of the finishing boring machine for the wheel hub hole, and is configured to support the finishing boring machine for the wheel hub hole.

The hydraulic automatic centering fixture is configured to place a to-be-processed workpiece, and is arranged on the boring machine body.

The CNC vertical sliding table is configured to control the spindle box, the CNC facing head and the cutter assembly to move up and down, and is arranged on the boring machine body.

The spindle box is configured to control rotation speeds of the CNC facing head and the cutter assembly, and is arranged on the CNC vertical sliding table.

The CNC facing head is configured to control a horizontal distance between the cutter assembly and the to-be-processed workpiece, and is arranged on the spindle box.

The cutter assembly is configured to process the to-be-processed workpiece, and is arranged on the CNC facing head.

The CNC facing head includes an alternating current (AC) servo motor, a driving shaft, a ball screw, a sliding member, and a linear guide. The AC servo motor is connected with the driving shaft through a coupling. The sliding member is fixedly connected with the ball screw, and the driving shaft is engaged with the ball screw, so as to drive the ball screw and the sliding member and move the cutter assembly on the linear guide.

Preferably, the CNC facing head further includes a conductive slip ring, the coupling, a first spiral bevel gear and a second spiral bevel gear. The conductive slip ring is configured for power distribution of the AC servo motor. The AC servo motor is connected with one end of the driving shaft through the coupling, so as to drive the driving shaft. The first spiral bevel gear is located at the other end of the driving shaft, the second spiral bevel gear is located on the ball screw, and the first spiral bevel gear is engaged with the second spiral bevel gear.

Preferably, the hydraulic automatic centering fixture includes a fixture positioning base and a fixture three-claw synchronous mechanism. The fixture three-claw synchronous mechanism includes three hydraulic motors and three trapezoidal lead screws, and each of the hydraulic motors is connected with one end of each of the trapezoidal lead screws. A first bevel gear is located at a center of the fixture positioning base, a second bevel gear is located at the other end of each of the trapezoidal lead screws, and the first bevel gear and the second bevel gear are engaged with each other, so as to realize synchronous clamping and loosening of the three trapezoidal lead screws.

Preferably, the CNC vertical sliding table includes a sliding table column, a sliding table body, a sliding table servo motor, a sliding table balance cylinder, a reducer, a leadscrew nut pair, and a sliding table linear guide. The sliding table column is connected with the boring machine body, and is configured to support the CNC vertical sliding table. The sliding table servo motor is arranged on the sliding table column. The sliding table servo motor is connected with the reducer. The reducer drives the leadscrew nut pair, so as to drive the sliding table body connected with the leadscrew nut pair to move on the sliding table linear guide. The sliding table body is connected with the spindle box. The sliding table balance cylinder counterweights the CNC vertical sliding table.

Preferably, the spindle box includes a main motor. The spindle box is connected with the driving shaft to control the rotation speed of the CNC facing head. The main motor is configured for speed regulation, a rotation speed of a spindle in the spindle box ranges from 50-500 rpm, and when a frequency is 50 Hz, the spindle box has a rotation speed of n=250 rpm.

Preferably, the cutter assembly includes a depth sensing switch, a first cutter, and a second cutter. The depth sensing switch is configured to determine a distance between the cutter assembly and the to-be-processed workpiece, the first cutter is configured for precision processing, and the second cutter is used for semi-precision processing.

Preferably, the finishing boring machine for a high-precision wheel hub hole further includes a hydraulic system and an electrical control system. The hydraulic system is connected with the hydraulic automatic centering fixture to provide hydraulic power for the hydraulic automatic centering fixture. The electrical control system is connected with the finishing boring machine body to control electric energy provided to the finishing boring machine.

Preferably, the finishing boring machine for a high-precision wheel hub hole further includes a machine protection component. The machine protection component is arranged on the boring machine body, and protects internal parts of the finishing boring machine from damage together with the boring machine body. The machine protection component adopts a stainless steel telescopic protective cover.

Preferably, the finishing boring machine for a high-precision wheel hub hole further includes a lubricator. The lubricator is arranged on each of the CNC vertical sliding table and the spindle box to lubricate internal parts of the finishing boring machine.

Preferably, the finishing boring machine for a high-precision wheel hub hole further includes an automatic chip removal system. The automatic chip removal system is arranged in the boring machine body. The automatic chip removal system includes a chain-plate type automatic chip remover and an iron chip collection box. The chain-plate type automatic chip remover is configured to collect iron chips generated during processing and clear the iron chips to the iron chip collection box, so as to realize automatic cleaning of the iron chips generated.

The embodiments of the present disclosure have the following beneficial effects:

(1) The finishing boring machine for the wheel hub hole provided by the embodiments of the present disclosure controls the CNC facing head to move up and down through the CNC vertical sliding table, controls the rotation speed of the CNC facing head through the spindle box, and drives the cutter assembly to move along the linear guide through the CNC facing head horizontally, so as to realize refined processing of the to-be-processed workpiece. Such CNC operations ensure quality of wheel hub holes and greatly improve production efficiency.

(2) The embodiments of the present disclosure further include the machine protection component, the lubricator, and the automatic chip removal system, which provides protection on the body of the finishing boring machine for the wheel hub hole, provides automatic lubrication for important parts of the finishing boring machine for the wheel hub hole, and automatically discharges and collects iron chips generated by the finishing boring machine for the wheel hub hole. Therefore, automatic processing of the finishing boring machine for the wheel hub hole in all aspects is realized, the time spent in manual cleaning is reduced, and the operation time of the machine is ensured.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show merely some embodiments of the present disclosure, and those of ordinary skill in the art may still derive other drawings from these accompanying drawings without creative efforts.

FIG. 1 is a main view structure diagram of a first embodiment provided by the present disclosure;

FIG. 2 is a top view structure diagram of the first embodiment provided by the present disclosure;

FIG. 3 is a side view structure diagram of the first embodiment provided by the present disclosure; and

FIG. 4 is a partial enlarged structure diagram of a CNC facing head of the first embodiment provided by the present disclosure.

Reference numerals: 1-boring machine body, 2-hydraulic automatic centering fixture, 201-fixture positioning base, 202-fixture three-claw synchronous mechanism, 203-hydraulic motor, 204-trapezoidal lead screw, 205-first bevel gear, 206-second bevel gear, 3-CNC vertical sliding table, 301-sliding table column, 302-sliding table body, 303-sliding table servo motor, 304-sliding table balance cylinder, 305-reducer, 306-leadscrew nut pair, 307-sliding table linear guide, 4-spindle box, 401-main motor, 5-CNC facing head, 501-AC servo motor, 502-conductive slip ring, 503-coupling, 504-driving shaft, 505-first spiral bevel gear, 506-ball screw, 507-second spiral bevel gear, 508-linear guide, 509-sliding member, 6-cutter assembly, 601-depth sensing switch, 602-first cutter, 603-second cutter, 7-hydraulic system, 8-electrical control system, 9-machine protection component, 10-lubricator, 11-automatic chip removal system, 1101-chain-plate type automatic chip remover, and 1102-iron chip collection box.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

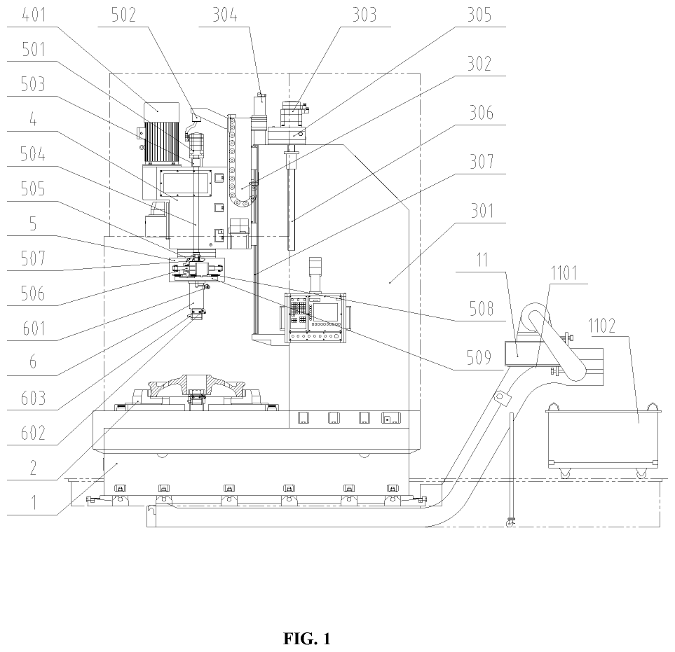

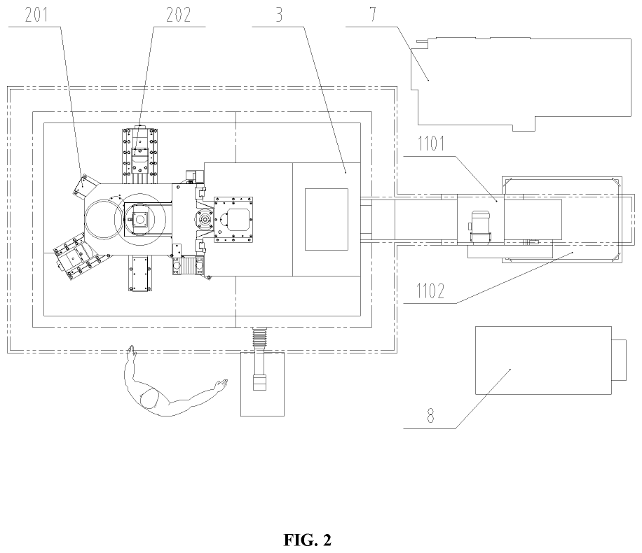

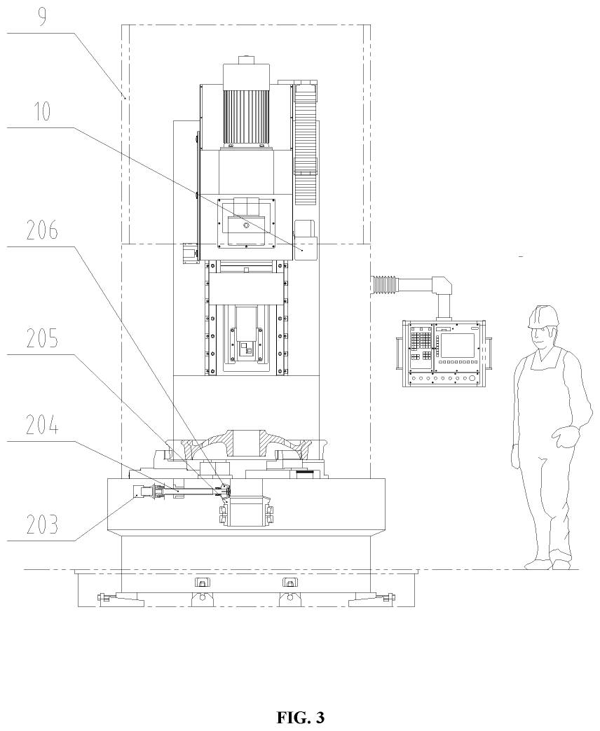

Referring to FIG. 1 to FIG. 3, a specific implementation of the present disclosure provides a finishing boring machine for a high-precision wheel hub hole. The finishing boring machine for the wheel hub hole includes a boring machine body 1, a hydraulic automatic centering fixture 2, a CNC vertical sliding table 3, a spindle box 4, a CNC facing head 5, a cutter assembly 6, a hydraulic system 7, an electrical control system 8, a machine protection component 9, a lubricator 10, and an automatic chip removal system 11. The boring machine body 1 is made of cast iron, is a main structure of the finishing boring machine for the wheel hub hole, and is configured to support the finishing boring machine for the wheel hub hole. The hydraulic automatic centering fixture 2 is configured to place a to-be-processed workpiece, can realize automatic clamping and loosening, and is arranged on the boring machine body. The CNC vertical sliding table 3 is configured to control the spindle box 4, the CNC facing head 5 and the cutter assembly 6 to move up and down, and is arranged on the boring machine body. The spindle box 4 is made of cast iron, is configured to control rotation speeds of the CNC facing head 5 and the cutter assembly 6, and is arranged on the CNC vertical sliding table 3. The CNC facing head 5 is configured to control a horizontal distance between the cutter assembly 6 and the to-be-processed workpiece, and is arranged on the spindle box. The cutter assembly 6 is configured to process the to-be-processed workpiece, and is arranged on the CNC facing head 5. The hydraulic system 7 is connected with the hydraulic automatic centering fixture 2 to provide hydraulic power for the hydraulic automatic centering fixture 2. The electrical control system 8 is connected with the finishing boring machine body to control electric energy provided to the finishing boring machine. The machine protection component 9 adopts a stainless steel telescopic protective cover, protects internal parts of the finishing boring machine from damage together with the boring machine body, and is arranged on the boring machine body 1. The lubricator 10 is arranged on each of the CNC vertical sliding table 3 and the spindle box 4 to lubricate internal parts of the finishing boring machine. The automatic chip removal system 11 is arranged in the boring machine body 1, and is configured to clear iron chips generated during processing by the finishing boring machine for the wheel hub hole.

The hydraulic automatic centering fixture 2 includes a fixture positioning base 201 and a fixture three-claw synchronous mechanism 202. The fixture positioning base 201 is configured to install the fixture three-claw synchronous mechanism 202, and cooperate with the fixture three-claw synchronous mechanism 202 to realize automatic clamping and loosening of the to-be-processed workpiece. A first bevel gear 205 is located at a center of the fixture positioning base 201. The fixture three-claw synchronous mechanism 202 includes three hydraulic motors 203 and three trapezoidal lead screws 204. A second bevel gear 206 is located at the end of the trapezoidal lead screw 204 away from the hydraulic motor 203. Under the action of the hydraulic system 7, the hydraulic motor 203 provides an outward or inward force on the trapezoidal lead screw 204. The trapezoidal lead screw 204 drives the second bevel gear 206 to be engaged with the first bevel gear 205, and the three trapezoidal lead screws 204 are clamped inwards or loosened outwards simultaneously. The hydraulic automatic centering fixture 2 realizes automatic clamping and loosening of the to-be-processed workpiece.

The CNC vertical sliding table 3 includes a sliding table column 301, a sliding table body 302, a sliding table servo motor 303, a sliding table balance cylinder 304, a reducer 305, a leadscrew nut pair 306, and a sliding table linear guide 307. The sliding table column 301 is connected with the boring machine body 1, and is configured to support the CNC vertical sliding table 3. The sliding table servo motor 303 is arranged on the sliding table column 301. The sliding table servo motor 303 is connected with the reducer 305. The reducer 305 is in driving connected with the leadscrew nut pair 306 to drive the leadscrew nut pair 306. The leadscrew nut pair 306 is connected with the sliding table body 302. The sliding table balance cylinder 304 counterweights the CNC vertical sliding table 3. Under the drive of the sliding table servo motor 303, the reducer 305 drives the leadscrew nut pair 306. The leadscrew nut pair 306 drives the sliding table body 302 to move back and forth on the sliding table linear guide 307. The sliding table body 302 is connected with the spindle box 4, the spindle box 4 is connected with the CNC facing head 5, and the CNC facing head 5 is connected with the cutter assembly 6. Finally, the spindle box 4, the CNC facing head 5, and the cutter assembly 6 are driven to move up and down together. The CNC vertical sliding table 3 realizes digital control of a horizontal height of the cutter assembly 6.

The spindle box 4 includes a main motor 401. The main motor 401 adopts a variable frequency motor for speed regulation, which can control a rotation speed of a spindle in the spindle box 4. The rotation speed of the spindle in the spindle box 4 ranges from 50-500 rpm, and when a frequency of the main motor 401 is 50 Hz, the spindle box has a rotation speed of n=250 rpm. The spindle in the spindle box 4 is connected with the CNC facing head 5, and the CNC facing head 5 is connected with the cutter assembly 6. The spindle box 4 realizes digital control of the rotation speed of the cutter assembly, and realizes rough and finish machining of the to-be-processed workpiece.

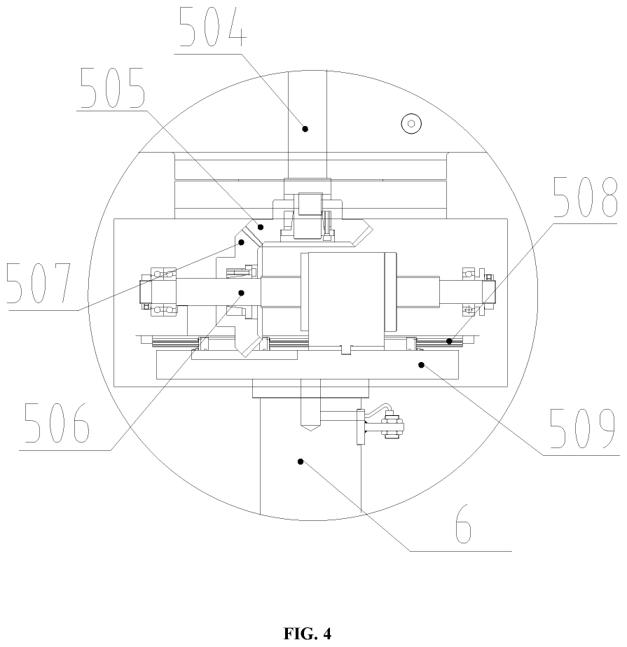

The CNC facing head 5 includes an AC servo motor 501, a conductive slip ring 502, a coupling 503, a driving shaft 504, a first spiral bevel gear 505, a ball screw 506, a second spiral bevel gear 507, a sliding member 509, and a linear guide 508. The conductive slip ring 502 is configured for power distribution of the AC servo motor 501. The AC servo motor 501 is connected with one end of the driving shaft 504 through the coupling 503. The first spiral bevel gear 505 is located at the other end of the driving shaft 504. The second spiral bevel gear 507 is located on the ball screw 506. The first spiral bevel gear 505 is engaged with the second spiral bevel gear 507. The sliding member 509 is fixedly connected with the ball screw 506, and is located on the linear guide 508. Referring to FIG. 4, when the AC servo motor 501 drives the driving shaft 504 through the coupling 503, the first spiral bevel gear 505 drives the second spiral bevel gear 507. The ball screw 506 moves left and right in the horizontal direction, and the sliding member 509 follows the ball screw 506 to move left and right in the horizontal direction on the linear guide 508. The sliding member 509 is connected with the cutter assembly 6. The sliding member 509 moves left and right in the horizontal direction, and the cutter assembly 6 follows the sliding member 509 to move left and right in the horizontal direction. The CNC facing head 5 realizes digital control of a horizontal distance between the cutter assembly 6 and the to-be-processed workpiece, and achieves automatic processing of a hub hole with a boring diameter in a range of φ 130-φ 500 mm.

The cutter assembly 6 includes a depth sensing switch 601, a first cutter 602, and a second cutter 603. The depth sensing switch 601 is configured to determine a distance between the cutter assembly 6 and the to-be-processed workpiece, the first cutter 602 is configured for precision processing, and the second cutter 603is used for semi-precision processing, so as to realize various degrees of processing of the to-be-processed workpiece.

The lubricator 10 is arranged on each of the sliding table column 301 and the spindle box 4 to lubricate the leadscrew nut pair 306 of the CNC vertical sliding table 3, the sliding table linear guide 307, and the bearing of the spindle box 4. Therefore, the smoothness of the internal parts of the finishing boring machine is automatically maintained.

The automatic chip removal system 11 includes a chain-plate type automatic chip remover 1101 and an iron chip collection box 1102. The chain-plate type automatic chip remover 1101 is arranged in the boring machine body 1, and is located below the hydraulic automatic centering fixture 2. Iron chips generated by the processing of the to-be-processed workpiece fall into the chain-plate type automatic chip remover 1101. The chain-plate type automatic chip remover 1101 centrally clears the iron chips into the iron chip collection box 1102, so as to realize automatic cleaning of the iron chips.

In conclusion, according to the finishing boring machine for the wheel hub hole, the CNC vertical sliding table 3, the spindle box 4, and the CNC facing head 5 are used to complete the CNC of the orientation and rotation speed of the cutter assembly 6. The hydraulic automatic centering fixture 2 is used to automatically control the clamping and loosening of the to-be-processed workpiece. The lubricator 10 is used to automatically maintain the internal parts of the finishing boring machine. The automatic chip removal system 11 is used to automatically clear the generated iron chips. The machine protection component 9 protects the finishing boring machine for the wheel hub hole. Therefore, all-around CNC and automation of the finishing boring machine for the wheel hub hole is realized, which ensures quality of wheel hub holes and greatly improves production efficiency.

The above disclosed is only a preferred embodiment of the present disclosure, and definitely should not be used to limit the scope of the claims of the present disclosure. Those person of ordinary skill in the art can understand all or some of the procedures for implementing the foregoing embodiments and make equivalent changes according to the claims of the present disclosure. The equivalent changes still fall within the scope of the present disclosure.

What is claimed is:

1. A finishing boring machine for a high-precision wheel hub hole, comprising: a boring machine body, a hydraulic automatic centering fixture, a computer numerical control (CNC) vertical sliding table, a spindle box, a CNC facing head, and a cutter assembly, wherein
the boring machine body is a main structure of the finishing boring machine, and is configured to support the finishing boring machine;
the hydraulic automatic centering fixture is arranged on the boring machine body and is configured to place a to-be-processed workpiece;
the CNC vertical sliding table is arranged on the boring machine body and is configured to control the spindle box, the CNC facing head and the cutter assembly to move up and down;
the spindle box is arranged on the CNC vertical sliding table and is configured to control rotation speeds of the CNC facing head and the cutter assembly;
the CNC facing head is arranged on the spindle box and is configured to control a horizontal distance between the cutter assembly and the to-be-processed workpiece;
the cutter assembly is arranged on the CNC facing head and is configured to process the to-be-processed workpiece; and
the CNC facing head comprises an alternating current (AC) servo motor, a driving shaft, a ball screw, a sliding member, and a linear guide; the AC servo motor is connected with the driving shaft through a coupling; and the sliding member is fixedly connected with the ball screw, and the driving shaft is engaged with the ball screw, so as to drive the ball screw and the sliding member and move the cutter assembly on the linear guide.

2. The finishing boring machine according to claim 1, wherein the CNC facing head further comprises a conductive slip ring, the coupling, a first spiral bevel gear and a second spiral bevel gear; the conductive slip ring is configured for power distribution of the AC servo motor; the AC servo motor is connected with one end of the driving shaft through the coupling, so as to drive the driving shaft; and the first spiral bevel gear is located at the other end of the driving shaft, the second spiral bevel gear is located on the ball screw, and the first spiral bevel gear is engaged with the second spiral bevel gear.

3. The finishing boring machine according to claim 1, wherein the hydraulic automatic centering fixture comprises a fixture positioning base and a fixture three-claw synchronous mechanism; the fixture three-claw synchronous mechanism comprises three hydraulic motors and three trapezoidal lead screws, and each of the hydraulic motors is connected with one end of each of the trapezoidal lead screws; and a first bevel gear is located at a center of the fixture positioning base, a second bevel gear is located at the other end of each of the trapezoidal lead screws, and the first bevel gear and the second bevel gear are engaged with each other, so as to realize synchronous clamping and loosening of the three trapezoidal lead screws.

4. The finishing boring machine according to claim 1, wherein the CNC vertical sliding table comprises a sliding table column, a sliding table body, a sliding table servo motor, a sliding table balance cylinder, a reducer, a leadscrew nut pair, and a sliding table linear guide; the sliding table column is connected with the boring machine body, and is configured to support the CNC vertical sliding table; the sliding table servo motor is arranged on the sliding table column; the sliding table servo motor is connected with the reducer; the reducer drives the leadscrew nut pair, so as to drive the sliding table body connected with the leadscrew nut pair to move on the sliding table linear guide; the sliding table body is connected with the spindle box; and the sliding table balance cylinder counterweights the CNC vertical sliding table.

5. The finishing boring machine according to claim 1, wherein the spindle box comprises a main motor; the spindle box is connected with the driving shaft to control the rotation speed of the CNC facing head; and the main motor is configured for speed regulation, a rotation speed of a spindle in the spindle box ranges from 50-500 rpm, and when a frequency is 50 Hz, the spindle box has a rotation speed of 250 rpm.

6. The finishing boring machine according to claim 1, wherein the cutter assembly comprises a depth sensing switch, a first cutter, and a second cutter; and the depth sensing switch is configured to determine a distance between the cutter assembly and the to-be-processed workpiece, the first cutter is configured for precision processing, and the second cutter is used for semi-precision processing.

7. The finishing boring machine according to claim 1, further comprising a hydraulic system and an electrical control system, wherein the hydraulic system is connected with the hydraulic automatic centering fixture to provide hydraulic power for the hydraulic automatic centering fixture; and the electrical control system is connected with the finishing boring machine body to control electric energy provided to the finishing boring machine

8. The finishing boring machine according to claim 1, further comprising a machine protection component, wherein the machine protection component is arranged on the boring machine body, and protects internal parts of the finishing boring machine from damage together with the boring machine body; and the machine protection component adopts a stainless steel telescopic protective cover.

9. The finishing boring machine according to claim 1, further comprising a lubricator, wherein the lubricator is arranged on each of the CNC vertical sliding table and the spindle box to lubricate internal parts of the finishing boring machine.

10. The finishing boring machine according to claim 1, further comprising an automatic chip removal system, wherein the automatic chip removal system is arranged in the boring machine body; the automatic chip removal system comprises a chain-plate type automatic chip remover and an iron chip collection box; and the chain-plate type automatic chip remover is configured to collect iron chips generated during processing and clear the iron chips to the iron chip collection box, so as to realize automatic cleaning of the iron chips generated.
